(19) United States
(12) Patent Application Publication
(10) Pub. No.: US 2012/0229737 A1
(43) Pub. Date: Sep. 13, 2012

(54) POLARIZATION FILM AND LIQUID CRYSTAL DISPLAY DEVICE COMPRISING SAME

(75) Inventors: Toru Ashida, Osaka-shi (JP); Tomoya Suzuki, Osaka-shi (JP)

(73) Assignee: SUMITOMO CHEMICAL COMPANY, LIMITED, Tokyo (JP)

(21) Appl. No.: 13/411,745

(22) Filed: Mar. 5, 2012

(30) Foreign Application Priority Data
Mar. 8, 2011 (JP) 2011-050839

(51) Int. Cl. G02F 1/1335; G02B 5/30

(52) U.S. Cl. 349/97; 359/487.02

(57) ABSTRACT

A polarization film comprising a polarization film substrate and a dye treated with an activated carbon, and a liquid crystal display device comprising the polarization film.

This nonprovisional application claims priority under 35 U.S.C. §119(a) on Patent Application No. 2011-050839 filed in JAPAN on Mar. 8, 2011, the entire contents of which are hereby incorporated by reference.

### FIELD OF THE INVENTION

The present invention relates to a polarization film and a liquid crystal display device comprising the same.

### BACKGROUND OF THE INVENTION

Polarization films are used for liquid crystal display devices such as a liquid crystal projector and a television for projection, and display devices mounted on automobiles such as car navigations.

US 2005/0127335 A1, US 2003/0098447 A1 and US 2001/0005748 A1 disclose a polarization film comprising a polyvinyl alcohol film and a dye which has been isolated according to the salting-out method from the reaction mixture obtained by its synthetic reaction and which is used as it is without purification.

### SUMMARY OF THE INVENTION

The present invention is to provide a polarization film and a liquid crystal display device comprising the same.

The present invention relates to the followings:
[1] A polarization film comprising a polarization film substrate and a dye treated with an activated carbon;
[2] The polarization film according to [1], wherein the dye treated with an activated carbon is one obtained by contacting a dye with an activated carbon in water;
[3] The polarization film according to [1] or [2], wherein the dye contains an azo compound;
[4] The polarization film according to [3], wherein the azo compound is a polyazo compound;
[5] A liquid crystal display device comprising the polarization film according to any one of [1] to [4].

### DESCRIPTION OF PREFERRED EMBODIMENTS

The polarization film of the present invention comprises a polarization film substrate and a dye treated with an activated carbon.

The activated carbon is not limited. Examples of the raw materials of the activated carbon include carbides such as coal, and products produced by carbonizing materials such as wood, sawdust, charcoal, palm shell, cellulose fibers and synthetic resins. Products obtained by conducting gas activation or chemical activation of the above-mentioned raw materials can be also used as activated carbon.

The specific surface area of the activated carbon is preferably 900 m²/g or more, more preferably 1000 m²/g or more and still more preferably 1100 m²/g or more. The specific surface area of the activated carbon is preferably 3000 m²/g or less, more preferably 2500 m²/g or less and still more preferably 2000 m²/g or less. When the specific surface area of the activated carbon is within the above-mentioned range, a polarization film having a higher degree of polarization can be obtained. In this specification, “specific surface area” means a value obtained by measuring according to BET method.

The average pore diameter of the activated carbon is preferably 1.0 nm or more, more preferably 2.0 nm or more and still more preferably 2.5 nm or more. The average pore diameter of the activated carbon is preferably 20 nm or less, more preferably 18 nm or less and still more preferably 15 nm or less. When the average pore diameter of the activated carbon is within the above-mentioned range, a polarization film having a higher degree of polarization can be obtained. In this specification, “average pore diameter” means a value obtained by measuring according to BJH method.

Examples of the method for treating the dye with the activated carbon include a method comprising contacting the dye with the activated carbon in water and a method comprising contacting the dye with the activated carbon in water and an organic solvent. Among them, preferred is a method comprising contacting the dye with the activated carbon in water (hereinafter, simply referred to as METHOD 1). Two or more kinds of the dye may be mixed to be treated with an activated carbon.

Specifically, METHOD 1 may be conducted by adding the dye and the activated carbon into water and then, stirring the resultant mixture. The adding order thereof is not limited, and the dye may be added into water followed by adding the activated carbon thereto, and the activated carbon may be added into water followed by adding the dye thereto. From the view point of easy dissolution of the dye in water, it is preferred that the dye is added to water to prepare a solution containing the dye, and then, the solution is mixed with the activated carbon to stir. The used amount of water is preferably 20 parts by mass or more relative to 1 part by mass of the dye, more preferably 25 parts by mass or more, and still more preferably 30 parts by mass or more. The used amount of water is preferably 100 parts by mass or less relative to 1 part by mass of the dye, more preferably 80 parts by mass or less, and still more preferably 65 parts by mass or less. The used amount of the activated carbon is preferably 0.1 part by mass or more relative to 1 part by mass of the dye, more preferably 0.3 part by mass or more, and still more preferably 0.5 part by mass or more. The used amount of the activated carbon is preferably 1.8 parts by mass or less relative to 1 part by mass of the dye, more preferably 1.5 parts by mass or less, and still more preferably 1.3 parts by mass or less.

The treating temperature of METHOD 1 is preferably 0° C. or more, preferably 10° C. or more, and still more preferably 20° C. or more. The treating temperature of METHOD 1 is preferably 50° C. or less, preferably 40° C. or less, and still more preferably 30° C. or less. The treating time of METHOD 1 is preferably 0.1 hour or more, preferably 0.5 hour or more, and still more preferably 1 hour or more. The treating time of METHOD 1 is preferably 7 hours or less, preferably 5 hours or less, and still more preferably 3 hours or less.

After mixing the dye, the activated carbon and water, the resultant mixture is usually filtrated to remove the activated carbon, and then, the dye is usually precipitated by salting-out from the filtrate followed by collecting the dye precipitated by filtration. The method of removing the activated carbon by filtration is not limited, and may be selected from the known filtration methods. The salting-out is usually carried out by adding an inorganic salt to the filtrate followed by stirring. Examples of the inorganic salt include an alkali metal chloride such as sodium chloride, potassium chloride and lithium chloride. The used amount of the inorganic salt is preferably 0.5 part by mass or more relative to 100 parts by mass of the filtrate, more preferably 1 part by mass or more, and still more preferably 5 parts by mass or more. The used amount of the inorganic salt is preferably 25 parts by mass or less relative to 100 parts by mass of the filtrate, more preferably 20 parts by mass or less, and still more preferably 15 parts by mass or less. The method of collecting the dye precipitated by filtration is not limited, and may be selected from the known filtration methods.

The dye is no limited, and examples thereof include an organic dye such as known dichroic dyes. The dichroic dye has an anisotropic absorption of light. The dye is preferably soluble in water.

Specific examples of the dye include an azo compound and a salt thereof.

The azo compound is preferably a polyazo compound. In this specification, “azo compound” means a compound having at least one azo group (—N═N—) within its molecule, and “polyazo compound” means a compound having two or more azo groups within its molecule. A water-soluble azo compound is preferable, and a water-soluble polyazo compound is more preferable. Examples of the polyazo compound include the compounds represented by the following formulae (1) to (4).

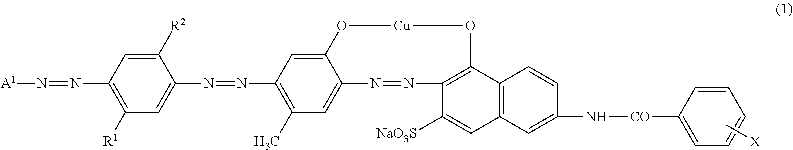

wherein A¹ represents a naphthyl group having one, two or three sulfo groups (—SO₃H) and optionally having one or more substituents, R¹ and R² independently each represent a hydrogen atom, an alkyl group having 1 to 4 carbon atoms or an alkoxy group having 1 to 4 carbon atoms, and X represents an amino group or a hydroxyl group,

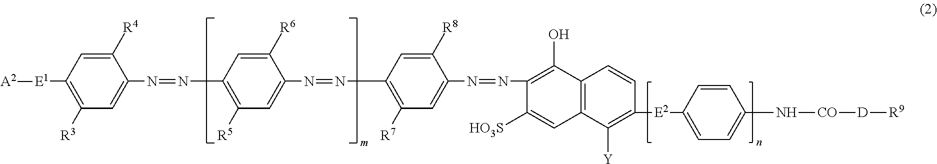

wherein A² represents a phenyl group having one or two groups selected from the group consisting of a sulfo group and a carboxyl group (—COOH) and optionally having one or more substituents, or a naphthyl group having one, two or three sulfo groups and optionally having one or more substituents, R³, R⁴, R⁵, R⁶, R⁷ and R⁹ independently each represent a hydrogen atom, an alkyl group having 1 to 4 carbon atoms or an alkoxy group having 1 to 4 carbon atoms, R⁹ represents a sulfo group, a carboxyl group or an alkoxycarbonyl group having 2 to 4 carbon atoms, D represents an alkanediyl group having 1 to 4 carbon atoms, a phenylene group or —CH═CH—, E¹ and E² independently each represent —NHCO—or —N═N—, Y represents a hydrogen atom or a sulfo group, m represents 0 or 1, n represents 0 or 1, with the proviso that when D represents a phenylene group, n represents 1,

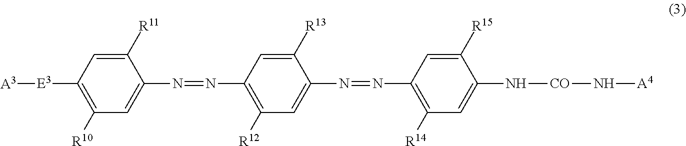

wherein A³ and A⁴ independently each represent a phenyl group having one or two groups selected from the group consisting of a sulfo group and a carboxyl group (—COOH) and optionally having one or more substituents, or a naphthyl group having one, two or three sulfo groups and optionally having one or more substituents, R¹⁰, R¹¹, R¹², R¹³, R¹⁴ and R¹⁵ independently each represent a hydrogen atom, an alkyl group having 1 to 4 carbon atoms or an alkoxy group having 1 to 4 carbon atoms, and E³ represents —NHCO— or —N═N—,

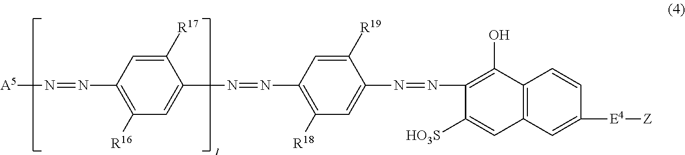

wherein A⁵ represents a phenyl group having one or two groups selected from the group consisting of a sulfo group and a carboxyl group (—COOH) and optionally having one or more substituents, or a naphthyl group having one, two or three sulfo groups and optionally having one or more substituents, R¹⁶, R¹⁷, R¹⁸ and R¹⁹ independently each represent a hydrogen atom, an alkyl group having 1 to 4 carbon atoms or an alkoxy group having 1 to 4 carbon atoms, E⁴ represents —NH—, —NHCO— or —N═N—, and Z represents a phenyl group optionally having one or two substituents, and the salts thereof.

Examples of the naphthyl group having one, two or three sulfo groups represented by A^{l} include a naphthyl group having one sulfo group such as a 5-sulfo-2-naphthyl group, 6-sulfo-2-naphthyl group, 7-sulfo-2-naphthyl group, 8-sulfo-2-naphthyl group, 4-sulfo-1-naphthyl group, 5-sulfo-l-naphthyl group, 6-sulfo-1-naphthyl group and 7-sulfo-1-naphthyl group; a naphthyl group having two sulfo groups such as a 1,5-disulfo-2-naphthyl group, 6,8-disulfo-2-naphthyl group, 4,8-disulfo-2-naphthyl group, 5,7-disulfo-2-naphthyl group, 3,6-disulfo-2-naphthyl group, 3,6-disulfo-l-naphthyl group and 4,6-disulfo-l-naphthyl group; and a naphthyl group having three sulfo groups such as a 1,5,7-trisulfo-2-naphthyl group, 3,6,8-trisulfo-2-naphthyl group and 4,6,8-trisulfo-2-naphthyl group. The naphthyl group optionally has one or more substituents, and examples thereof include an alkyl group having 1 to 4 carbon atoms and an alkoxy group having 1 to 4 carbon atoms. Examples of the alkyl group having 1 to 4 carbon atoms include a linear alkyl group having 1 to 4 carbon atoms such as a methyl group, an ethyl group, a propyl group and a butyl group; a branched chain alkyl group having 3 to 4 carbon atoms such as an isopropyl group, an isobutyl group and a tert-butyl group; and a cyclic alkyl group having 3 to 4 carbon atoms such as a cyclopropyl group and a cyclobutyl group. Among them, preferred is a linear alkyl group having 1 to 4 carbon atoms, and more preferred is a methyl group. Examples of the alkoxyl group having 1 to 4 carbon atoms include a linear alkoxy group having 1 to 4 carbon atoms such as a methoxy group, an ethoxy group, a propoxy group and a butoxy group; a branched chain alkoxy group having 3 to 4 carbon atoms such as an isopropoxy group, an isobutoxy group and a tert-butoxy group; and a cyclic alkoxy group having 3 to 4 carbon atoms such as a cyclopropoxy group and a cyclobutoxy group. Among them, preferred is a linear alkoxy group having 1 to 4 carbon atoms, and more preferred is a methoxy group.

A¹ is preferably a naphthyl group having two or three sulfo groups from the viewpoint of the stainability, and a 1,5-disulfo-2-naphthyl group, 6,8-disulfo-2-naphthyl group, 4,8-disulfo-2-naphthyl group, 5,7-disulfo-2-naphthyl group and 3,6-disulfo-2-naphthyl group are more preferable.

Examples of the alkyl group having 1 to 4 carbon atoms represented by R¹ and R² include a linear alkyl group having 1 to 4 carbon atoms such as a methyl group, an ethyl group, a propyl group and a butyl group; a branched chain alkyl group having 3 to 4 carbon atoms such as an isopropyl group, an isobutyl group and a tert-butyl group; and a cyclic alkyl group having 3 to 4 carbon atoms such as a cyclopropyl group and a cyclobutyl group.

Examples of the alkoxy group having 1 to 4 carbon atoms represented by R¹ and R² include a linear alkoxy group having 1 to 4 carbon atoms such as a methoxy group, an ethoxy group, a propoxy group and a butoxy group; a branched chain alkoxy group having 3 to 4 carbon atoms such as an isopropoxy group, an isobutoxy group and a tert-butoxy group; and a cyclic alkoxy group having 3 to 4 carbon atoms such as a cyclopropoxy group and a cyclobutoxy group. It is preferred that R¹ and R² independently each represent a hydrogen atom, a methyl group or a methoxy group.

In the formula (1), X represents an amino group or a hydroxyl group, and X is preferably bonded to 2-, 4- or 6-position, and more preferably bonded to 4-position.

Examples of the phenyl group having one or two groups selected from the group consisting of a sulfo group and a carboxyl group (—COOH) represented by A² include a 2-sulfophenyl group, a 3-sulfophenyl group, a 4-sulfophenyl group, a 2-carboxyphenyl group, a 3-carboxyphenyl group, a 4-carboxyphenyl group, a 2,4-disulfophenyl group, a 2,5-disulfophenyl group, a 3,5-dicarboxyphenyl group, a 2-carboxy-4-sulfophenyl group, and a 2-carboxy-5-sulfophenyl group. The phenyl group optionally has one or more substituents, and examples thereof include an alkyl group having 1 to 4 carbon atoms and an alkoxy group, having 1 to 4 carbon atoms. Examples of the alkyl group having 1 to 4 carbon atoms and the alkoxy group having 1 to 4 carbon atoms include the same as described above. Examples of the phenyl group having one or two groups selected from the group consisting of a sulfo group and a carboxyl group and having one or more substituents include a 2-methyl-4-sulfophenyl group and a 3-methyl-4-sulfophenyl group. Among them, preferred is a phenyl group having one or two sulfo groups from the viewpoint of the stainability, and more preferred is a 4-sulfophenyl group.

Examples of the naphthyl group having one, two or three sulfo groups and optionally having one or more substituents represented by A² include those as same as described in A¹. Among them, preferred is a naphthyl group having two or three sulfo groups, and more preferred is a disulfo-2-naphthyl group such as a 1,5-disulfo-2-naphthyl group, a 6,8-disulfo-2-naphthyl group, a 4,8-disulfo-2-naphthyl group, a 5,7-disulfo-2-naphthyl group and a 3,6-disulfo-2-naphthyl group.

Examples of the alkyl group having 1 to 4 carbon atoms or an alkoxy group having 1 to 4 carbon atoms represented by R³, R⁴, R⁵, R⁶, R⁷ and R⁸ include those as same as described in R¹ and R². It is preferred that R³, R⁴, R⁵, R⁶, R⁷ and R⁸ independently each represent a hydrogen atom or a methyl group.

Examples of the alkoxycarbonyl group having 2 to 4 carbon atoms represented by R⁹ include a methoxycarbonyl group, an ethoxycarbonyl group, a propoxycarbonyl group and a butoxycarbonyl group, and a methoxycarbonyl group and an ethoxycarbonyl group are preferable, and a methoxycarbonyl group is more preferable. R⁹ is preferably a carboxyl group or an alkoxycarbonyl group having 2 to 4 carbon atoms, and more preferably a carboxyl group, a methoxycarbonyl group or an ethoxycarbonyl group, and especially preferably a carboxyl group or a methoxycarbonyl group.

Examples of the alkanediyl group having 1 to 4 carbon atoms represented by D include a methylene group (—CH₂—), an ethylene group (—CH₂CH₂—), a propylene group (—CH₂CH₂CH₂—) and a butylene group (—CH₂CH₂CH₂CH₂—), and a methylene group and an ethylene group are preferable, and an ethylene group is more preferable. D is preferably an alkanediyl group having 1 to 4 carbon atoms, and more preferably a methylene group or an ethylene group, and especially preferably a methylene group.

Y is preferably a hydrogen atom.

Examples of the phenyl group having one or two groups selected from the group consisting of a sulfo group and a carboxyl group (—COOH) and optionally having one or more substituents represented by A³ and A⁴ include those as same as described in A², and a phenyl group having one sulfo group is preferable. Examples of the naphthyl group having one, two or three sulfo groups and optionally having one or more substituents represented by A³ and A⁴ include those as same as described in A¹, and a naphthyl group having two sulfo groups is preferable, and a disulfo-2-naphthyl group is more preferable.

Examples of the alkyl group having 1 to 4 carbon atoms and the alkoxy group having 1 to 4 carbon atoms represented by R¹⁰, R¹¹, R¹², R¹³, R¹⁴ and R¹⁵ include those as same as described in R¹ and R², and a linear alkyl group, a branched chain alkyl group, a linear alkoxy group and a branched chain alkoxy group are preferable. It is preferred that R¹⁰, R¹¹, R¹², R¹³, R¹⁴ and R¹⁵ independently each represent a hydrogen atom, a methyl group or a methoxy group from the viewpoint of the dichroic property.

Examples of the phenyl group having one or two groups selected from the group consisting of a sulfo group and a carboxyl group (—COOH) and optionally having one or more substituents represented by A⁵ include those as same as described in A², and a phenyl group having one sulfo group is preferable. Examples of the naphthyl group having one, two or three sulfo groups and optionally having one or more substituents represented by A⁵ include those as same as described in A¹, and a naphthyl group having two sulfo groups is preferable, and a disulfo-2-naphthyl group is more preferable.

Examples of the alkyl group having 1 to 4 carbon atoms and the alkoxy group having 1 to 4 carbon atoms represented by R¹⁶, R¹⁷, R¹⁸ and R¹⁹ include those as same as described in R¹ and R², and a linear alkyl group, a branched chain alkyl group, a linear alkoxy group and a branched chain alkoxy group are preferable. It is preferred that R¹⁶, R¹⁷, R¹⁸ and R¹⁹ independently each represent a hydrogen atom, a methyl group or a methoxy group from the viewpoint of the dichroic property.

The phenyl group represented by Z may have one or two substituents, and examples of the substituent include a hydroxyl group (—OH), an amino group (—NH₂), an alkyl group having 1 to 4 carbon atoms, an alkoxy group having 1 to 4 carbon atoms and a sulfo group. Examples of the alkyl group having 1 to 4 carbon atoms and the alkoxy group having 1 to 4 carbon atoms include those as same as described in R¹ and R². Z is preferably a phenyl group, an aminophenyl group or a hydroxyphenyl group, and more preferably a phenyl group, a 4-aminophenyl group or a 4-hydroxyphenyl group.

Examples of the salts of the compounds represented by the formulae (1) to (4) include alkali metal salts thereof such as lithium salts thereof, sodium salts thereof and potassium salts thereof, organic amine salts thereof such as ethanolamine salts thereof and alkylamine salts thereof, and ammonium salts thereof. Among them, preferred are sodium salts thereof from the viewpoint that they are easily contained in the polarization film substrate. The compounds represented by the formulae (1) to (4) and the salts thereof can be produced according to the methods described in US 2005/0127335 A1, US 2003/0098447 A1 and US 2001/0005748 A1.

Specific examples of salts of the compound represented by the formula (1) include the salts represented by the following formulae (I-1) to (I-7).

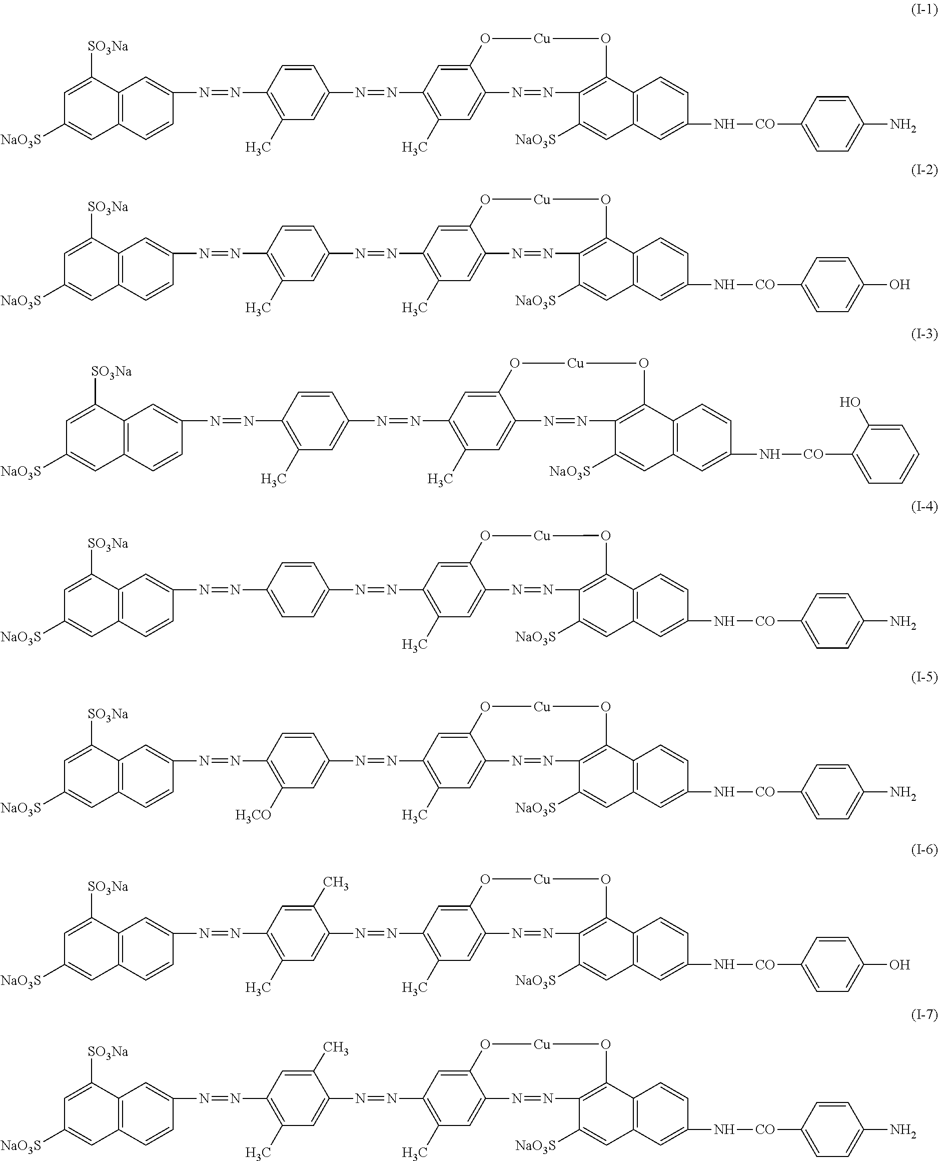

Specific examples of salts of the compound represented by the formula (2) include the salts represented by the following formulae (II-1) to (11-23).

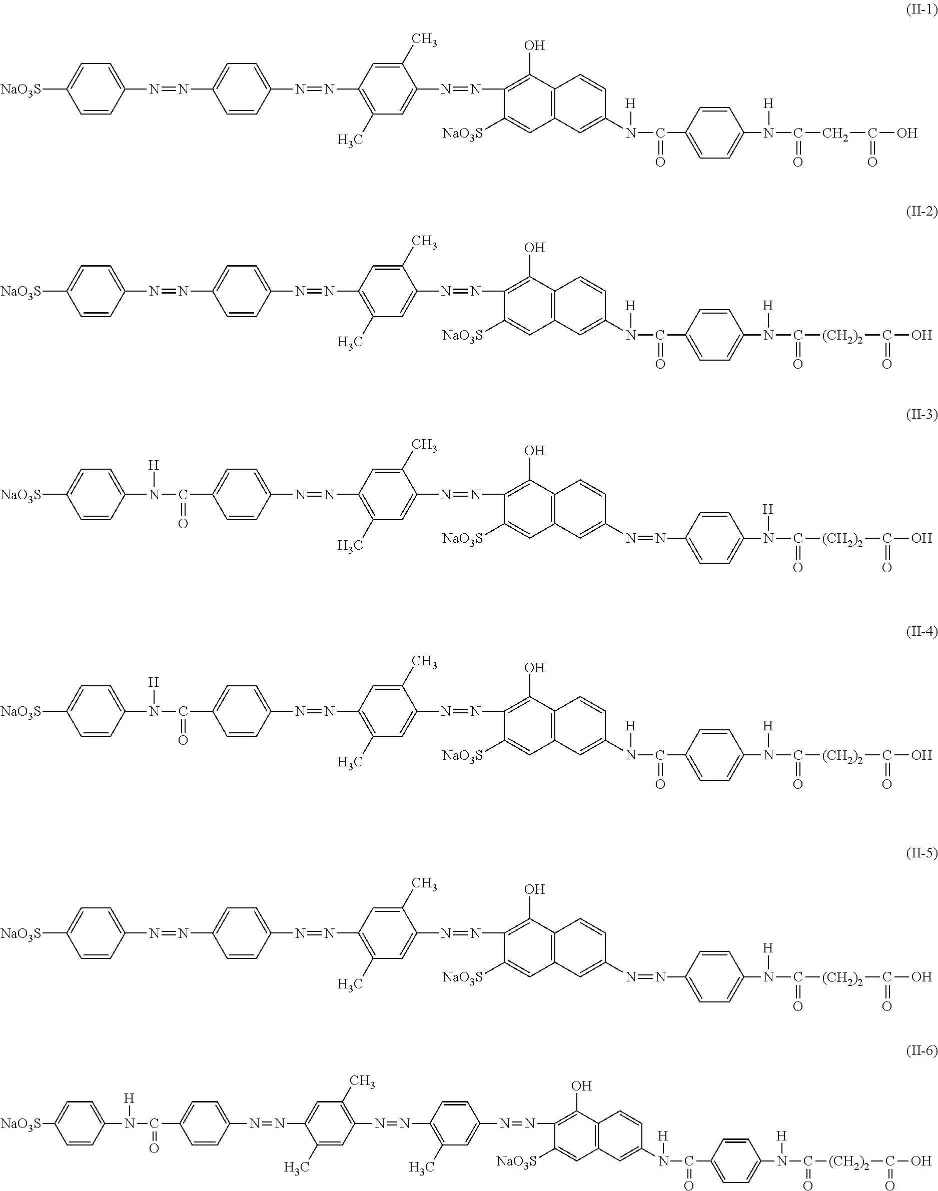

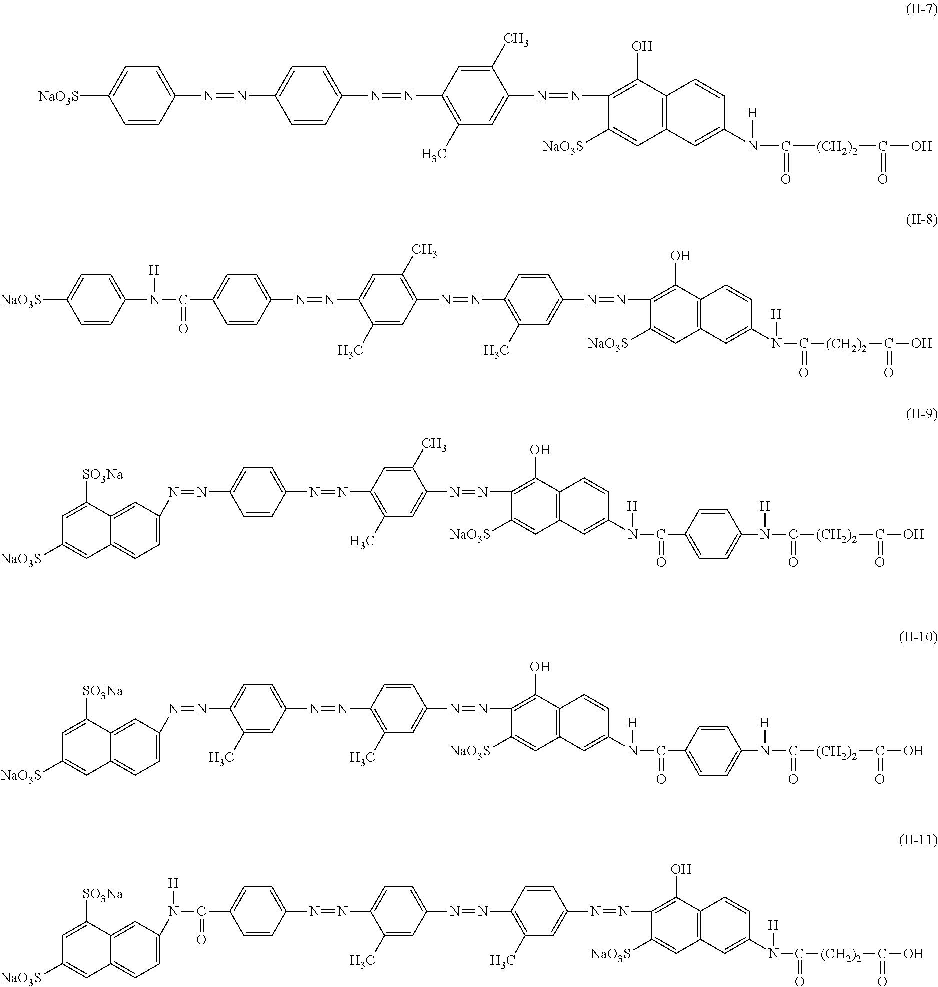

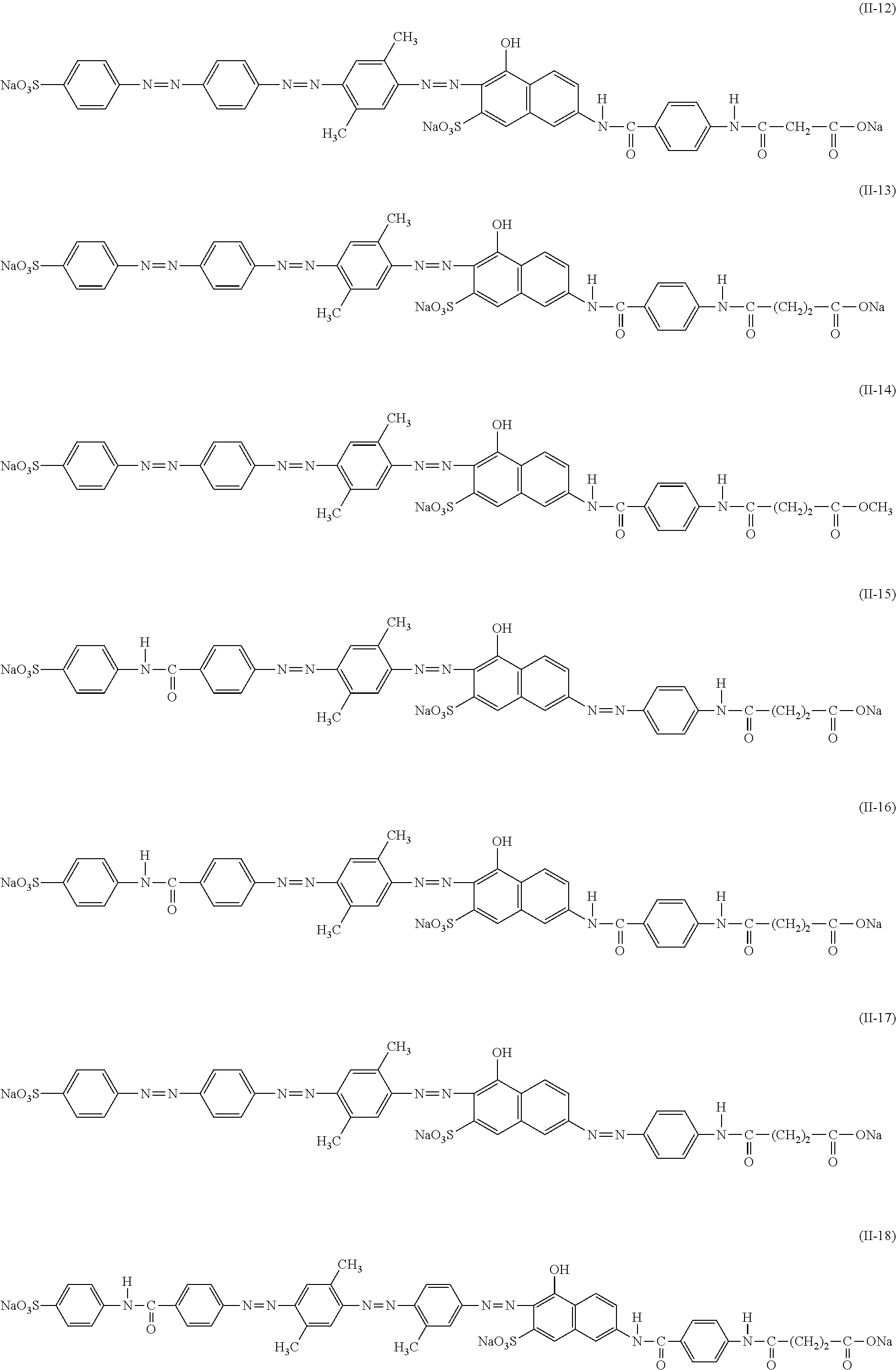

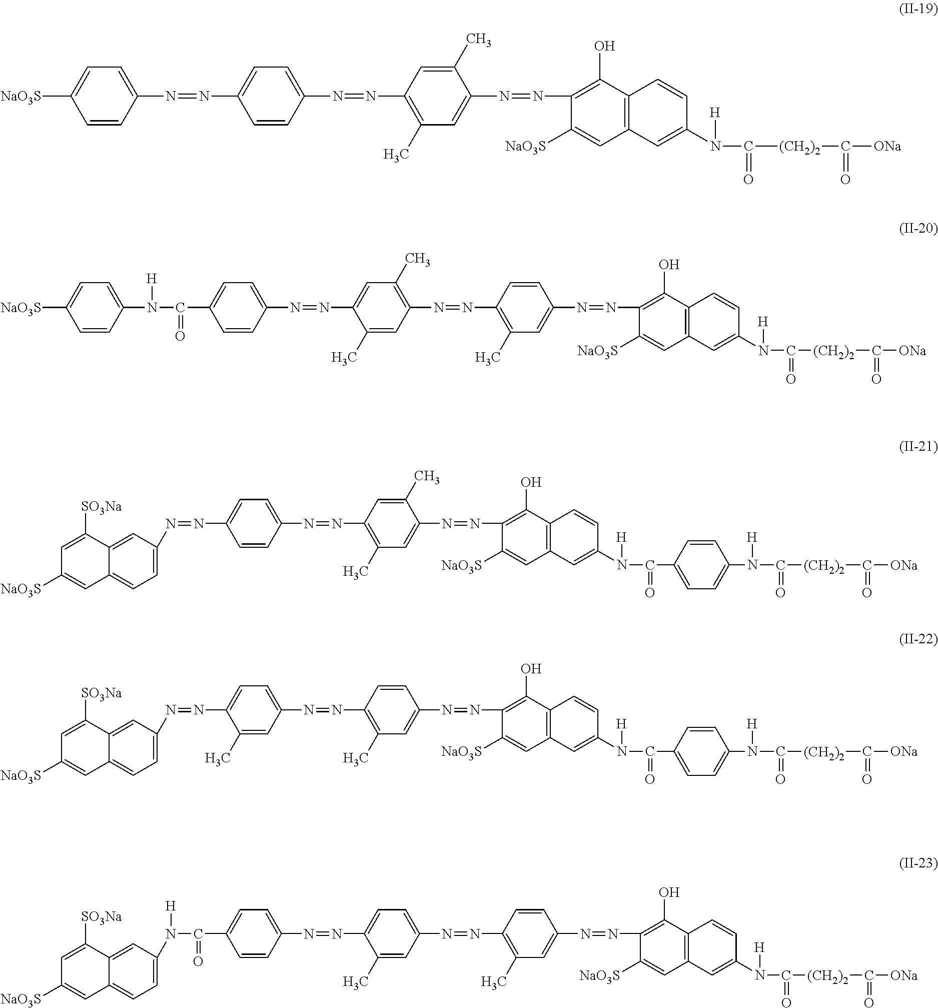

Specific examples of salts of the compound represented by the formula (3) include the salts represented by the following formulae (IV-1) to (IV-7).

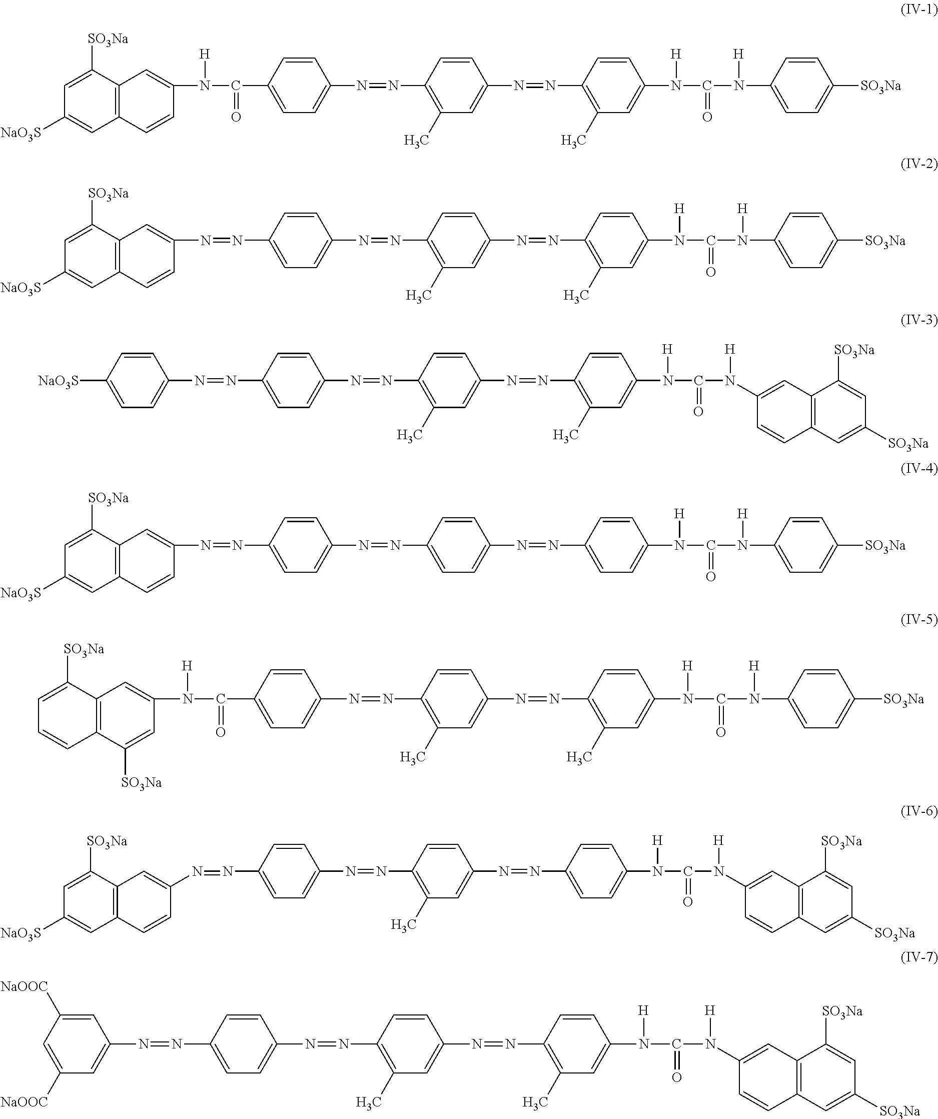

Specific examples of salts of the compound represented by the formula (4) include the salts represented by the following formulae (V-1) to (V-4) and (VI-1).

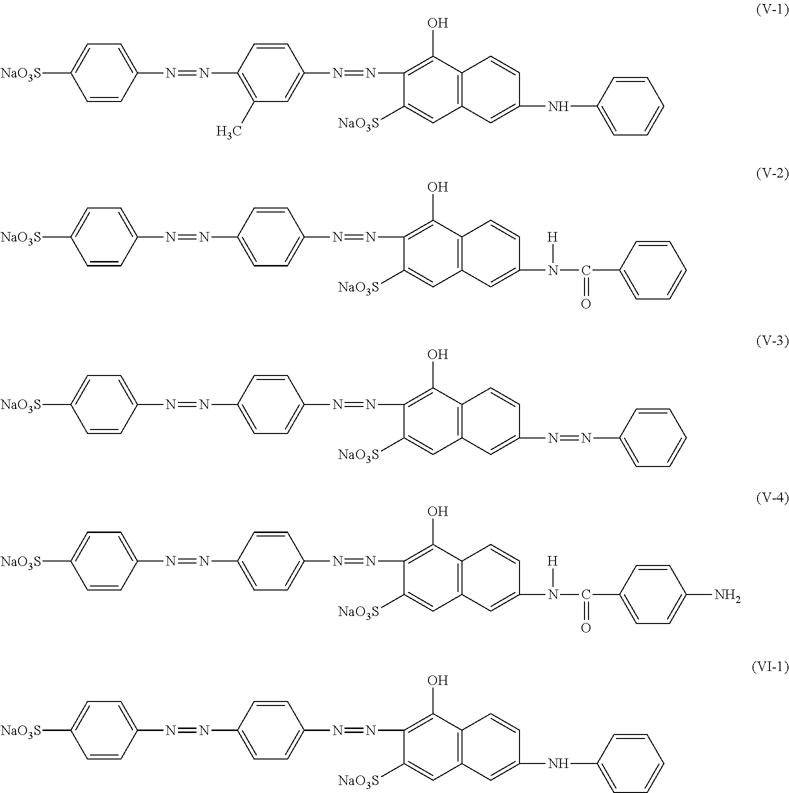

Examples of the other organic dye include the following compounds expressed by Color Index Generic Name: C.I. Direct Yellow 12, C.I. Direct Yellow 28, C.I. Direct Yellow 44, C.I. Direct Orange 26, C.I. Direct Orange 39, C.I. Direct Orange 107, C.I. Direct Red 2, C.I. Direct Red 31, C.I. Direct Red 79, C.I. Direct Red 81, C.I. Direct Red 117 and C.I. Direct Red 247. These organic dyes may be used alone and two or more thereof may be used in combination. The other organic dyes, the compounds represented by the formulae (1) to (4) and the salts thereof may be used in combination.

Among them, preferred are the compounds represented by the formulae (1) to (3) and the salts thereof. In order to modify hue and improve polarization performance, two or more dyes may be used in combination. A polarization film suitable for a liquid crystal projector can be obtained by selecting a dye having a higher dichroic property, and further having a superior light resistance as the dye used for the polarization film.

The polarization film of the present invention may contain a dye not treated with an activated carbon in addition to the dye treated with an activated carbon. Examples of the dye not treated with an activated carbon include the compounds represented by the above-mentioned formulae (1) to (4) and the salts thereof, and the other organic dye described above. When the polarization film contains a dye not treated with an activated carbon in addition to the dye treated with an activated carbon, the content of the dye not treated with an activated carbon is preferably 0.01 part by mass or more relative to 1 part by mass of the dye treated with an activated carbon. The content of the dye not treated with an activated carbon is preferably 0.2 part by mass or less relative to 1 part by mass of the dye treated with an activated carbon, more preferably 0.1 part by mass or less and still more preferably 0.05 part by mass or less.

Examples of the polarization film substrate include a substrate made of a polyvinyl alcohol-based resin, a substrate made of a polyvinyl acetate resin, a substrate made of an ethylene/vinyl acetate (EVA) resin, a substrate made of a polyamide resin and a substrate made of a polyester resin. Examples of the polyvinyl alcohol-based resin include polyvinyl alcohol which is a partial or complete saponified product of polyvinyl acetate, a saponified product of copolymers of vinyl acetate with the other copolymerizable monomer (for example, an olefin such as ethylene and propylene, an unsaturated carboxylic acid such as crotonic acid, acrylic acid, methacrylic acid and maleic acid, an unsaturated sulfonic acid and a vinyl ether) such as a saponified EVA resin; and a polyvinyl acetal obtained by modifying polyvinyl alcohol with an aldehyde (for example, a polyvinyl formal). Among them, preferred is a substrate made of a polyvinyl alcohol-based resin, and more preferred is a substrate made of a polyvinyl alcohol from the viewpoint of adsorbing performance and orientation performance of the dye.

The thickness of the polarization film substrate may be adjusted depending on the desired strength or the like. The thickness of the polarization film substrate is preferably 10 μm or more, more preferably 20 μm or more, and still more preferably 50 μm or more. The thickness of the polarization film substrate is preferably 300 μm or less, more preferably 200 μm or less and still more preferably 100 μm or less.

The polarization film substrate is preferably subjected to an alignment treatment. Examples of the alignment treatment include a mechanical alignment such as stretching and rubbing, and a chemical alignment such as photo-alignment.

The polarization film of the present invention can be produced by causing the polarization film substrate to contain the dye treated with an activated carbon. The polarization film of the present invention can be usually produced by immersing the polarization film substrate in an aqueous solution containing the dye treated with an activated carbon. The content of the dye treated with an activated carbon in the aqueous solution is preferably 0.0001% by mass or more, more preferably 0.001% by mass or more, and still more preferably 0.01% by mass or more. The content of the dye treated with an activated carbon in the aqueous solution is preferably 10% by mass or less, more preferably 1% by mass or less, and still more preferably 0.1% by mass or less. The aqueous solution containing the dye treated with an activated carbon may contain a dyeing aid, and examples thereof include sodium sulfate (Na₂SO₄.10H₂O). The content of the dyeing aid in the aqueous solution containing the dye treated with an activated carbon is preferably 0.05% by mass or more, more preferably 0.1% bymass or more, and still more preferably 0.15% by mass or more. The content of the dyeing aid in the aqueous solution containing the dye treated with an activated carbon is preferably 10% by mass or less, more preferably 5% by mass or less, and still more preferably 2% by mass or less.

The immersing temperature on immersing the polarization film substrate in an aqueous solution containing the dye treated with an activated carbon is preferably 40° C. or more, more preferably 50° C. or more, and still more preferably 60° C. or more. The immersing temperature on dipping the polarization film substrate in an aqueous solution containing the dye treated with an activated carbon is preferably 80° C. or less, more preferably 75° C. or less, and still more preferably 72° C. or less.

The alignment of the dye can be conducted by stretching a polarization film substrate before dyeing or a dyed polarization film substrate. Examples of the stretching the polarization film substrate include wet methods and dry methods.

A dyed polarization film substrate may be subjected to a post-treatment such as boric acid treatment for the purpose of improving light transmittance, degree of polarization and light resistance of a polarization film. The boric acid treatment is conducted by immersing the polarization film in an aqueous boric acid solution. The boric acid treatment is suitably carried out depending on kinds of a polarization film substrate and kinds of a dye. The concentration of boric acid in the aqueous boric acid solution is preferably 1% by mass or more, more preferably 3% by mass or more, and still more preferably 5% by mass or more. The concentration of boric acid in the aqueous boric acid solution is preferably 15% by mass or less, more preferably 13% by mass or less, and still more preferably 10% by mass or less. The temperature of the aqueous boric acid solution used is preferably 30° C. or more, more preferably 40° C. or more, and still more preferably 50° C. or more. The temperature of the aqueous boric acid solution used is preferably 85° C. or less, more preferably 83° C. or less, and still more preferably 80° C. or less. As necessary, a fix treatment may be used in combination using an aqueous solution containing a cationic polymer compound.

The polarization film after dyeing, the boric acid treatment or the fix treatment is preferably isolated from the aqueous solution followed by washing with water. The temperature of water used for washing is preferably 10° C. or more, and more preferably 15° C. or more. The temperature of water used for washing is preferably 40° C. or less, and more preferably 30° C. or less. The polarization film after washing is preferably dried. Examples of the method for drying the polarization film include natural drying, through circulation drying and drying under reduced pressure. The drying temperature is preferably 10° C. or more and more preferably 25° C. or more. The drying temperature is preferably 80° C. or less and more preferably 70° C. or less. The drying time is preferably 5 seconds or more and more preferably 10 seconds or more. The drying time is preferably 60 minutes or less and more preferably 30 minutes or less. If the drying temperature and the drying time are within the above-mentioned range, respectively, the polarization film can be dried without any harmful effect on the polarization film substrate.

A polarization plate can be prepared by putting a protective film excellent in optical transparency and mechanical strength on one surface or both surfaces of the polarization film of the present invention. The materials forming the protective film may be one conventionally used, and examples thereof include cellulose acetate-based films, acrylic-based films, fluorine resin-based films such as ethylene tetrafluoride/propylene hexafluoride copolymer, polyester-based films, polyolefin-based films and polyamide-based films.

The polarization film of the present invention can be used for various display devices. The display device is a device having a display element, and it comprises a light emitting device or a luminescent device as luminescent source. Examples of the display device include liquid crystal display devices, organic electroluminescence (EL) display devices, inorganic electroluminescence (EL) display devices, electron-emitter display devices such as electric field emission display devices (FED) and surface-conduction electron-emitter display devices (SED), electronic papers which are display devices using electronic ink or electrophoretic device, plasma display devices, projection display devices such as grating light valve display devices and display devices having digital micromirror devices (DMD), and piezoelectric ceramic displays. Examples of the liquid crystal display devices include transmissive liquid crystal display devices, semi-transmissive liquid crystal display devices, reflective liquid crystal display devices, direct-view-type liquid crystal display devices and projection liquid crystal display devices. The above-mentioned display devices may be display devices displaying two-dimensional image and may be display devices displaying three-dimensional image.

### EXAMPLES

The present invention will be described more specifically by Examples, which are not construed to limit the scope of the present invention.

The “%” and “part(s)” used to represent the content of any component and the amount of any material used in the following examples and comparative examples are on a mass basis unless otherwise specifically noted.

### [Evaluation Method]

Maximum Adsorption Wave Length of a Polarization Film (λₘₐₓ)

A polarization film was exposed to linear polarized light of which vibration direction was parallel to stretching direction (absorption axis direction) of the polarization film substrate, and transmittances at each wave length were measured using a spectrophotometer “UV-2450” manufacture by Shimadzu Corporation. From the results, wave length wherein transmittance became minimum was set as λₘₐₓ.

### Degree of Polarization

A polarization film was exposed to linear polarized light of which wave length was λₘₐₓ, and the transmittance (T1) of the direction perpendicular to the stretching direction of the polarization film substrate (transmission axis direction), and the transmittance (T2) of the stretching direction of the polarization film substrate (absorption axis direction) were measured using a spectrophotometer “UV-2450” manufacture by Shimadzu Corporation. From the results, degree of polarization was calculated using the following formula:

Unit transmittance (%)=T1+T2

Degree of polarization (%)=(T1−T2)/(T1+T2)}^{1/2}

[Preparation of a Dye Treated with an Activated Carbon]

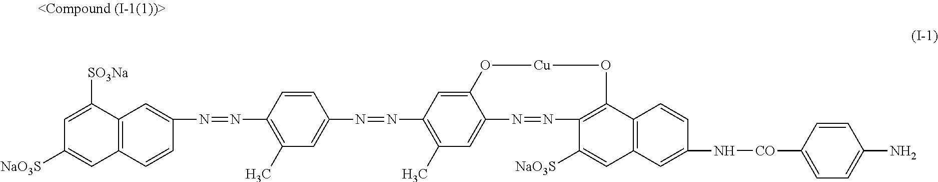

Eleven point eight (11.8) parts of the compound represented by the formula (I-1) was dissolved in 400 parts of water to prepare an aqueous dye solution. To the aqueous dye solution prepared, 7 parts of activated carbon available from Wako Pure Chemical Industries, Ltd. and having 1200 m²/g of specific surface area and 2.8 nm of average pore diameter was added, and the resultant mixture was stirred at 25° C. for 2 hours. The mixture was filtrated to obtain 360 parts of a filtrate. To the filtrate, 36 parts of sodium chloride was added and the resultant mixture was stirred at 30° C. for 2 hours to conduct salting-out. The precipitate was collected by filtration and the precipitated collected was dried at 80° C. for 24 hours to obtain 9.4 parts of the compound obtained by treating the compound represented by the formula (I-1) with an activated carbon, which is called as Compound (I-1(1)).

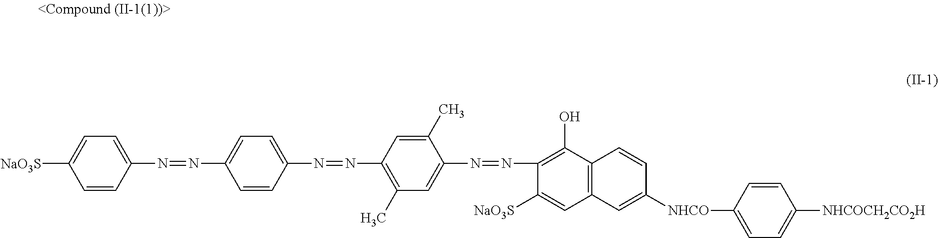

Nine point one (9.1) parts of the compound represented by the formula (II-1) was dissolved in 500 parts of water to prepare an aqueous dye solution. To the aqueous dye solution prepared, 7 parts of activated carbon available from Wako Pure Chemical Industries, Ltd. and having 1200 m²/g of specific surface area and 2.8 nm of average pore diameter was added, and the resultant mixture was stirred at room temperature (25° C.) for 2 hours. The mixture was filtrated to obtain 450 parts of a filtrate. To the filtrate, 45 parts of sodium chloride was added and the resultant mixture was stirred at 30° C. for 2 hours to conduct salting-out. The precipitate was collected by filtration and the precipitated collected was dried at 80° C. for 24 hours to obtain 7.2 parts of the compound obtained by treating the compound represented by the formula (II-1) with an activated carbon, which is called as Compound (II-1(1)).

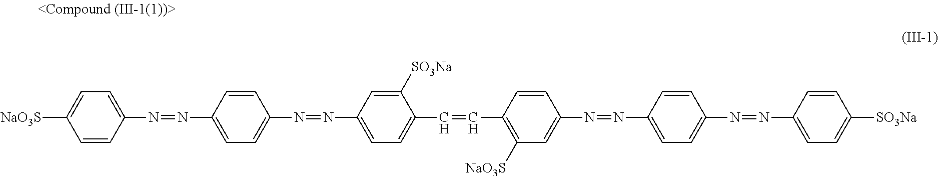

Ten point four (10.4) parts of the compound represented by the formula (III-1) which was C.I. Direct Orange 39 was dissolved in 500 parts of water to prepare an aqueous dye solution. To the aqueous dye solution prepared, 8 parts of activated carbon available from Wako Pure Chemical Industries, Ltd. and having 1200 m²/g of specific surface area and 2.8 nm of average pore diameter was added, and the resultant mixture was stirred at room temperature (25° C.) for 2 hours. The mixture was filtrated to obtain 450 parts of a filtrate. To the filtrate, 45 parts of sodium chloride was added and the resultant mixture was stirred at 30° C. for 2 hours to conduct salting-out. The precipitate was collected by filtration and the precipitated collected was dried at 80° C. for 24 hours to obtain 8.2 parts of the compound obtained by treating the compound represented by the formula (III-1) with an activated carbon, which is called as Compound (III-1(1)).

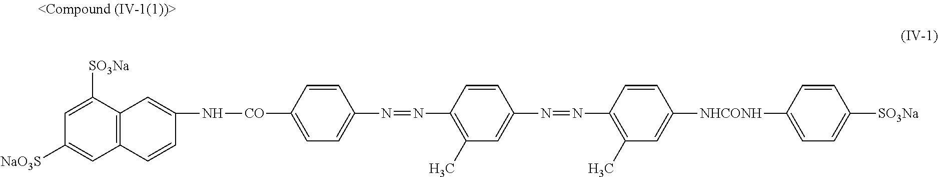

Eleven point one (11.1) parts of the compound represented by the formula (IV-1) was dissolved in 500 parts of water to prepare an aqueous dye solution. To the aqueous dye solution prepared, 7 parts of activated carbon available from Wako Pure Chemical Industries, Ltd. and having 1200 m²/g of specific surface area and 2.8 nm of average pore diameter was added, and the resultant mixture was stirred at room temperature (25° C.) for 2 hours. The mixture was filtrated to obtain 450 parts of a filtrate. To the filtrate, 45 parts of sodium chloride was added and the resultant mixture was stirred at 30° C. for 2 hours to conduct salting-out. The precipitate was collected by filtration and the precipitated collected was dried at 80° C. for 24 hours to obtain 9.5 parts of the compound obtained by treating the compound represented by the formula (IV-1) with an activated carbon, which is called as Compound (IV-1(1)).

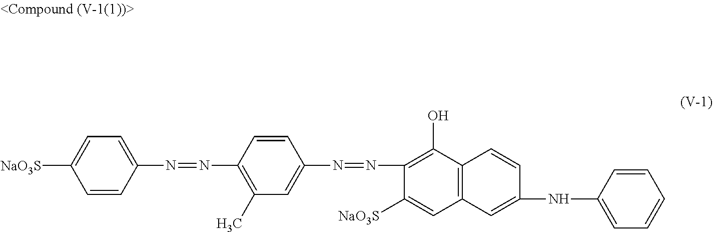

Seven point one (7.1) parts of the compound represented by the formula (V-1) was dissolved in 400 parts of water to prepare an aqueous dye solution. To the aqueous dye solution prepared, 8 parts of activated carbon available from Wako Pure Chemical Industries, Ltd. and having 1200 m²/g of specific surface area and 2.8 nm of average pore diameter was added, and the resultant mixture was stirred at room temperature (25° C.) for 2 hours. The mixture was filtrated to obtain 350 parts of a filtrate. To the filtrate, 35 parts of sodium chloride was added and the resultant mixture was stirred at 30° C. for 2 hours to conduct salting-out. The precipitate was collected by filtration and the precipitated collected was dried at 80° C. for 24 hours to obtain 5.4 parts of the compound obtained by treating the compound represented by the formula (V-1) with an activated carbon, which is called as Compound (V-1(1)).

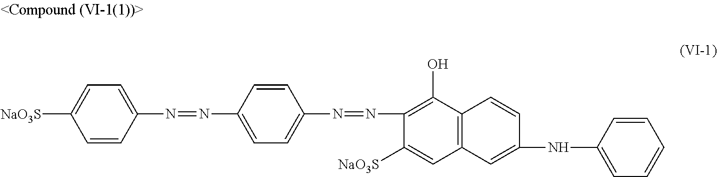

Six point five (6.5) parts of the compound represented by the formula (VI-1) was dissolved in 400 parts of water to prepare an aqueous dye solution. To the aqueous dye solution prepared, 8 parts of activated carbon available from Wako Pure Chemical Industries, Ltd. and having 1200 m²/g of specific surface area and 2.8 nm of average pore diameter was added, and the resultant mixture was stirred at room temperature (25° C.) for 2 hours. The mixture was filtrated to obtain 350 parts of a filtrate. To the filtrate, 35 parts of sodium chloride was added and the resultant mixture was stirred at 30° C. for 2 hours to conduct salting-out. The precipitate was collected by filtration and the precipitated collected was dried at 80° C. for 24 hours to obtain 5.0 parts of the compound obtained by treating the compound represented by the formula (VI-1) with an activated carbon, which is called as Compound (VI-1(1)).

### [Preparation of Polarization Film]

### Example 1

An aqueous solution containing Compound (I-1(1)) of which concentration was 0.025% and sodium sulfate (dyeing aid) of which concentration was 0.2% was prepared. A polyvinyl alcohol film [Kuraray Vinylon #7500, manufactured by Kuraray Co., Ltd.] having a thickness of 75 μm was stretched five-fold along a longitudinal axis to prepare a polarization film substrate. This polyvinyl alcohol film was immersed for 3 minutes, while keeping its tense condition, into the aqueous solution prepared the above of which temperature was 70° C. Then, this film was immersed in a 7.5% boric acid aqueous solution of which temperature was 70° C. for 5 minutes, and then, was taken out and washed with water of which temperature was 20° C. for 20 seconds, and dried at 50° C. for 1 minute to obtain a polarization film. λₘₐₓ of the polarization film obtained was 610 nm. The degree of polarization of the polarization film obtained at λₘₐₓ was measured, and the degree of polarization at a unit transmittance of 43% was 99.85%.

### Comparative Example 1

A polarization film was prepared according to the same manner as those described in Example 1 except that the compound represented by the formula (I-1) was used in place of Compound (I-1(1)). λₘₐₓ of the polarization film obtained was 610 nm. The degree of polarization of the polarization film obtained at λₘₐₓ was measured, and the degree of polarization at a unit transmittance of 43% remained at 99.80%.

### Example 2

An aqueous solution containing Compound (II-1(1)) of which concentration was 0.025% and sodium sulfate (dyeing aid) of which concentration was 0.2% was prepared.

A polarization film was prepared according to the same manner as those described in Example 1 except that the aqueous solution prepared the above was used in place of the aqueous solution containing Compound (I-1(1))). λₘₐₓ of the polarization film obtained was 550 nm. The degree of polarization of the polarization film obtained at λₘₐₓ was measured, and the degree of polarization at a unit transmittance of 43% was 99.92%.

### Comparative Example 2

A polarization film was prepared according to the same manner as those described in Example 2 except that the compound represented by the formula (II-1) was used in place of Compound (II-1(1)). λₘₐₓ of the polarization film obtained was 550 nm. The degree of polarization of the polarization film obtained at λₘₐₓ was measured, and the degree of polarization at a unit transmittance of 43% remained at 99.85%.

### Example 3

An aqueous solution containing Compound (II-1(1)) of which concentration was 0.025%, Compound (III-1(1)) of which concentration was 0.005% and sodium sulfate (dyeing aid) of which concentration was 0.2% was prepared.

A polarization film was prepared according to the same manner as those described in Example 1 except that the aqueous solution prepared the above was used in place of the aqueous solution containing Compound (I-1 (1))). λₘₐₓ of the polarization film obtained was 550 nm. The degree of polarization of the polarization film obtained at λₘₐₓ was measured, and the degree of polarization at a unit transmittance of 43% was 99.70%.

### Comparative Example 3

A polarization film was prepared according to the same manner as those described in Example 3 except that the compound represented by the formula (II-1) was used in place of Compound (II-1(1)) and the compound represented by the formula (III-1) was used in place of Compound (III-1(1)). λₘₐₓ of the polarization film obtained was 550 nm. The degree of polarization of the polarization film obtained at λₘₐₓ was measured, and the degree of polarization at a unit transmittance of 43% remained at 99.65%.

### Example 4

An aqueous solution containing Compound (IV-1(1)) of which concentration was 0.025% and sodium sulfate (dyeing aid) of which concentration was 0.2% was prepared.

A polarization film was prepared according to the same manner as those described in Example 1 except that the aqueous solution prepared the above was used in place of the aqueous solution containing Compound (I-1(1))). λₘₐₓ of the polarization film obtained was 440 nm. The degree of polarization of the polarization film obtained at λₘₐₓ was measured, and the degree of polarization at a unit transmittance of 43% was 99.85%.

### Comparative Example 4

A polarization film was prepared according to the same manner as those described in Example 4 except that the compound represented by the formula (IV-1) was used in place of Compound (IV-1(1)). λₘₐₓ of the polarization film obtained was 440 nm. The degree of polarization of the polarization film obtained at λₘₐₓ was measured, and the degree of polarization at a unit transmittance of 43% remained at 99.83%.

### Example 5

An aqueous solution containing Compound (IV-1(1)) of which concentration was 0.025%, Compound (V-1(1)) of which concentration was 0.005% and sodium sulfate (dyeing aid) of which concentration was 0.2% was prepared.

A polarization film was prepared according to the same manner as those described in Example 1 except that the aqueous solution prepared the above was used in place of the aqueous solution containing Compound (I-1 (1))). λₘₐₓ of the polarization film obtained was 440 nm. The degree of polarization of the polarization film obtained at λₘₐₓ was measured, and the degree of polarization at a unit transmittance of 43% was 99.64%.

### Comparative Example 5

A polarization film was prepared according to the same manner as those described in Example 3 except that the compound represented by the formula (IV-1) was used in place of Compound (IV-1(1)) and the compound represented by the formula (V-1) was used in place of Compound (V-1(1)). λₘₐₓ of the polarization film obtained was 440 nm. The degree of polarization of the polarization film obtained at λₘₐₓ was measured, and the degree of polarization at a unit transmittance of 43% remained at 99.60%.

### Example 6

An aqueous solution containing Compound (III-1(1)) of which concentration was 0.025% and sodium sulfate (dyeing aid) of which concentration was 0.2% was prepared.

A polarization film was prepared according to the same manner as those described in Example 1 except that the aqueous solution prepared the above was used in place of the aqueous solution containing Compound (I-1(1))). λₘₐₓ of the polarization film obtained was 440 nm. The degree of polarization of the polarization film obtained at λₘₐₓ was measured, and the degree of polarization at a unit transmittance of 43% was 99.68%.

### Comparative Example 6

A polarization film was prepared according to the same manner as those described in Example 4 except that the compound represented by the formula (III-1) was used in place of Compound (III-1(1)). λₘₐₓ of the polarization film obtained was 440 nm. The degree of polarization of the polarization film obtained at Aₘₐₓ was measured, and the degree of polarization at a unit transmittance of 43% remained at 99.64%.

### Example 7

An aqueous solution containing Compound (III-1(1)) of which concentration was 0.025%, Compound (V-1(1)) of which concentration was 0.005% and sodium sulfate (dyeing aid) of which concentration was 0.2% was prepared.

A polarization film was prepared according to the same manner as those described in Example 1 except that the aqueous solution prepared the above was used in place of the aqueous solution containing Compound (I-1(1))). λₘₐₓ of the polarization film obtained was 440 nm. The degree of polarization of the polarization film obtained at λₘₐₓ was measured, and the degree of polarization at a unit transmittance of 43% was 99.35%.

### Comparative Example 7

A polarization film was prepared according to the same manner as those described in Example 3 except that the compound represented by the formula (III-1) was used in place of Compound (III-1(1)) and the compound represented by the formula (V-1) was used in place of Compound (V-1(1)). λₘₐₓ of the polarization film obtained was 440 nm. The degree of polarization of the polarization film obtained at λₘₐₓ was measured, and the degree of polarization at a unit transmittance of 43% remained at 99.30%.

### Example 8

An aqueous solution containing Compound (III-1(1)) of which concentration was 0.025%, Compound (VI-1(1)) of which concentration was 0.005% and sodium sulfate (dyeing aid) of which concentration was 0.2% was prepared.

A polarization film was prepared according to the same manner as those described in Example 1 except that the aqueous solution prepared the above was used in place of the aqueous solution containing Compound (I-1(1))). λₘₐₓ of the polarization film obtained was 440 nm. The degree of polarization of the polarization film obtained at λₘₐₓ was measured, and the degree of polarization at a unit transmittance of 43% was 99.30%.

### Comparative Example 8

A polarization film was prepared according to the same manner as those described in Example 3 except that the compound represented by the formula (III-1) was used in place of Compound (III-1(1)) and the compound represented by the formula (VI-1) was used in place of Compound (VI-1(1)). λₘₐₓ of the polarization film obtained was 440 nm. The degree of polarization of the polarization film obtained at λₘₐₓ was measured, and the degree of polarization at a unit transmittance of 43% remained at 99.20%.

TABLE 1

| | | | | | | Properties | |
|---|---|---|---|---|---|---|---|
| | | | | | | of | |
| | Aqueous Solution Containing Dye | | | | | Polarization | |
| | | | | | Na₂SO₄ | Film | |
| | | | | | (Dyeing | | Degree |
| | Dye 1 | | Dye 2 | | Aid) | | of |
| | | Content | | Content | Content | | polari- |
| | | (% by | | (% by | (% by | λₘₐₓ | zation |
| | Kind | mass) | Kind | mass) | mass) | (nm) | (%) |
| Ex. 1 | I-1(1) | 0.025 | | | 0.2 | 610 | 99.85 |
| Comp. | I-1 | 0.025 | | | 0.2 | 610 | 99.80 |
| Ex. 1 | | | | | | | |
| Ex. 2 | II-1(1) | 0.025 | | | 0.2 | 550 | 99.92 |
| Comp. | I1-1 | 0.025 | | | 0.2 | 550 | 99.85 |
| Ex. 2 | | | | | | | |
| Ex. 3 | II-1(1) | 0.025 | III-1(1) | 0.005 | 0.2 | 550 | 99.70 |
| Comp. | II-1 | 0.025 | III-1 | 0.005 | 0.2 | 550 | 99.65 |
| Ex. 3 | | | | | | | |
| Ex. 4 | IV-1(1) | 0.025 | | | 0.2 | 440 | 99.85 |
| Comp. | IV-1 | 0.025 | | | 0.2 | 440 | 99.83 |
| Ex. 4 | | | | | | | |
| Ex. 5 | IV-1(1) | 0.025 | V-1(1) | 0.005 | 0.2 | 440 | 99.64 |
| Comp. | IV-1 | 0.025 | V-1 | 0.005 | 0.2 | 440 | 99.60 |
| Ex. 5 | | | | | | | |
| Ex. 6 | III-1(1) | 0.025 | | | 0.2 | 440 | 99.68 |
| Comp. | III-1 | 0.025 | | | 0.2 | 440 | 99.64 |
| Ex. 6 | | | | | | | |
| Ex. 7 | III-1(1) | 0.025 | V-1(1) | 0.005 | 0.2 | 440 | 99.35 |
| Comp. | III-1 | 0.025 | V-1 | 0.005 | 0.2 | 440 | 99.30 |
| Ex. 7 | | | | | | | |
| Ex. 8 | III-1(1) | 0.025 | VI-1(1) | 0.005 | 0.2 | 440 | 99.30 |
| Comp. | III-1 | 0.025 | VI-1 | 0.005 | 0.2 | 440 | 99.20 |
| Ex. 8 | | | | | | | |

The polarization film of the present invention has high degree of polarization.

What is claimed is:

1. A polarization film comprising a polarization film substrate and a dye treated with an activated carbon.

2. The polarization film according to claim 1, wherein the dye treated with an activated carbon is one obtained by contacting a dye with an activated carbon in water.

3. The polarization film according to claim 1, wherein the dye contains an azo compound.

4. The polarization film according to claim 3, wherein the azo compound is a polyazo compound.

5. A liquid crystal display device comprising the polarization film according to any one of claims 1 to 4.
